(19) United States
(12) Patent Application Publication
(10) Pub. No.: US 2025/0348412 A1
(43) Pub. Date: Nov. 13, 2025

(54) SOFTWARE APPLICATION BUILD TESTING WITH DUPLICATE FAILURE DETECTION

(71) Applicant: SAP SE, Walldorf (DE)

(72) Inventors: Yang Xu, Xi'an (CN); Yong Li, Xi'an (CN); Qiao-luan Xie, Xi'an (CN); Chao Liu, Xi'an (CN); Xiaoxiao Zhang, Xi'an (CN); Thomas Bach, Rauenberg (DE); Sunghun Kim, Seoul (KR); Sanghun Kang, Seoul (KR)

(21) Appl. No.: 18/660,946

(22) Filed: May 10, 2024

(51) Int. Cl. G06F 11/36

(52) U.S. Cl. CPC G06F 11/3636

(57) ABSTRACT

Various examples described herein are directed to systems and methods for debugging a software application. A computing system may access a call stack. The call stack may describe a first plurality of function calls made by a software application prior to a first crash of the software application and an order of the first plurality of function calls. The computing system may filter the call stack to generate a first filtered call stack and determine a similarity score for the first crash and a second crash of the software application. The determining of the similarity score may be based on comparing the first filtered call stack to a second filtered call stack. The second filtered call stack may describe a second plurality of function calls made by the software application prior to the second crash of the software application and an order of the second plurality of function calls.

### BACKGROUND

Traditionally modes of software development involve developing a software application and then performing error detection and debugging on the application before it is released to customers and/or other users. Error detection and debugging were time-consuming, largely manual activities. Because releases were typically separated in time by several months or even years, however, smart project planning could leave sufficient time and resources for adequate error detection and debugging.

### BRIEF DESCRIPTION OF DRAWINGS

The present disclosure is illustrated by way of example and not limitation in the following figures.

FIG. 1 is a diagram showing one example of an environment for software testing.

FIG. 2 is a diagram showing one example of a CI/CD pipeline incorporating various software testing described herein.

FIG. 3 is a flowchart showing one example of a process flow that may be executed in the environment of FIG. 1.

FIG. 4 is a flowchart showing one example of a process flow that may be executed in the environment of FIG. 1 to filter a call stack.

FIG. 5 is a flowchart showing one example of a process flow that may be executed in the environment of FIG. 1 to determining a similarity score between a source call stack and a target call stack.

FIG. 6 is a block diagram showing one example of a software architecture for a computing device.

FIG. 7 is a block diagram of a machine in the example form of a computer system within which instructions may be executed for causing the machine to perform any one or more of the methodologies discussed herein.

### DETAILED DESCRIPTION

Various examples described herein are directed to software testing and error detection with duplicate crash detection.

In many software delivery environments, modifications to a software application are coded, tested, and sometimes released to users on a fast-paced timescale, sometimes quarterly, bi-weekly, or even daily. Also, large-scale software applications may be serviced by a large number of software developers, with many developers and developer teams making modifications to the software application.

In some example arrangements, a continuous integration/continuous delivery (CI/CD) pipeline arrangement is used to support a software application. According to CI/CD pipeline, a developer entity maintains an integrated source of an application, called a mainline or mainline build. The mainline build is the most recent build of the software application. At release time, the mainline build is released to and may be installed at various production environments such as, for example, at public cloud environments, private cloud environments, and/or on-premise computing systems where users can access and utilize the software application.

Between releases, a development team or teams may work to update and maintain the software application. When it is desirable for a developer to make a change to the application, the developer checks out a version of the mainline build from a source code management (SCM) system into a local developer repository. The developer builds and tests modifications to the mainline. When the modifications are completed and tested, the developer initiates a commit operation. In the commit operation, the CI/CD pipeline executes an additional series of integration and acceptance tests to generate a new mainline build that includes the developer's modifications.

Applying the various integration and acceptance tests may comprise applying one or more test cases to a new build. A test case may comprise input data describing a set of input parameters provided to a build and result data describing how the build is expected to behave when provided with the set of input parameters. Executing a test case may comprise providing the set of input parameters to the build and observing how it responds. For example, a build may pass the test case if it generates an output that is equivalent to the result data. On the other hand, if the build crashes, resulting in a crash failure, or generates incorrect output, this may be considered a failure of the test case.

When a new build suffers a crash failure of at least one test case, a corrective action may be performed. The corrective action may include restoring a previous version of the build to prevent the potentially erroneous new build from reaching production. The corrective action may also include referring the new build to a developer user to identify and correct any errors in the build that may have caused the test case failure or failures.

Because a single new build may be subject to multiple test cases, it is possible for the new build to generate crash failures in response to more than one test case. In some examples, a build that crashes during one test case may be more likely to also crash during other test cases. Further, not all crash failures are independent. For example, a single error in a new build may cause multiple crash failures. Crash failures caused by the same underlying error in a build are referred to herein as duplicate crash failures or duplicate failures.

When the new build is referred to a developer user to identify and correct errors, the developer user may be provided with a record of each crash failure. The developer user may analyze each crash failure to identify and correct the underlying error or errors. This is even when some or all of the crash failures are duplicate failures. Even if the developer user focuses on identifying duplicate crash failures, simply determining that two test case failures are duplicates can involve a considerable amount of time and manual labor.

Another issue arises when a new build crashes during one or more test cases due to a known problem that also existed in prior builds. For example, it may not be desirable to fail to move a new build two production simply because it crashes due to errors that are also included in the current production build. Accordingly, developer users analyzing test case crash failures may also need to determine whether the crash failures are due to known issues with the software application or due to modifications introduced by the new build. Comparing a crash failure to known bugs/errors with a software application may also involve a considerable amount of time and manual labor.

Various examples described herein address these and other challenges utilizing a method for debugging a software application by identifying duplicate crash failures. For example, a testing computing system may utilize call stacks generated by a new build during crash failures. A call stack is data describing functions called during execution of a software application. The testing system may filter the call stack to generate a filtered call stack, where the filtering includes removing function calls, adding function calls, and/or changing the order of function calls indicated by the call stack data. Filtered call stack data from one crash failure may be compared to filtered call stack data from a second crash failure to determine a similarity score for the two crash failures. If the similarity score meets a threshold, then the two failures may be duplicate failures.

The testing system may utilize the similarity score of pairs of crash failures to classify new crash failures as duplicates of one another or as duplicates of crash failures caused by known errors in the software application. This may increase the automation and decrease the manual effort associated with correcting errors in the software application.

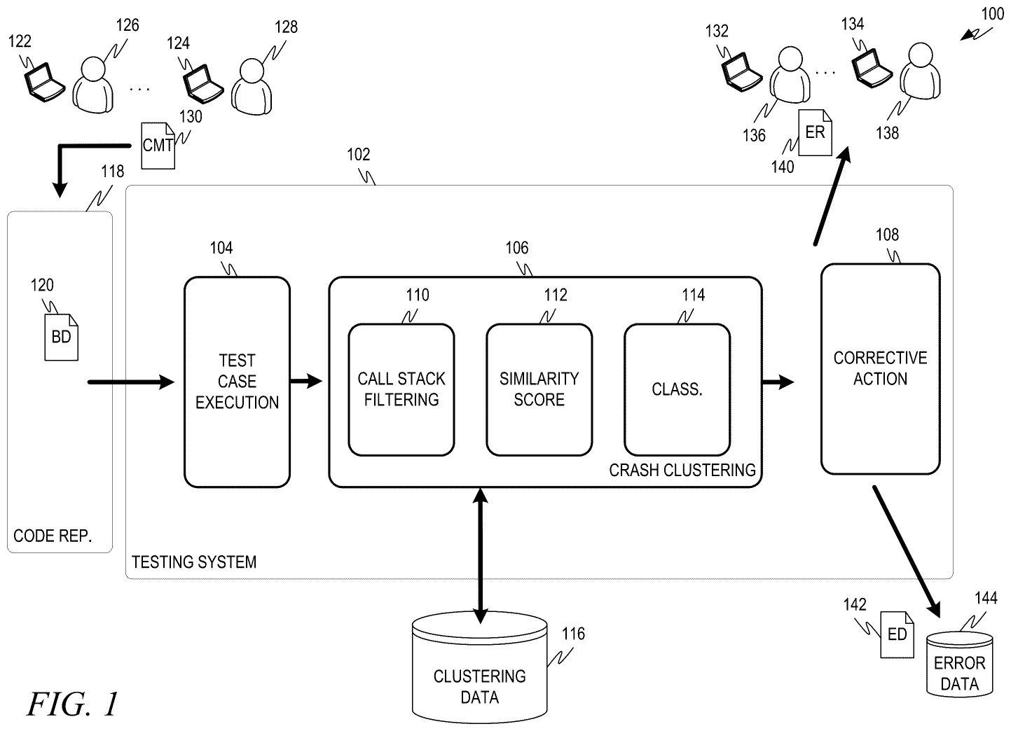

FIG. 1 is a diagram showing one example of an environment 100 for software testing. The environment 100 comprises a testing system 102 and a code repository 118, which may be all or part of an SCM system. The testing system 102 may include one or more computing devices that may be located at a single geographic location and/or distributed across different geographic locations.

One or more developer users 126, 128 may generate commit operations, such as commit operation 130. Developer users 126, 128 may utilize user computing devices 122, 124. User computing devices 122, 124 may be or include any suitable computing device such as, for example, desktop computers, laptop computers, tablet computers, mobile computing devices, and/or the like. For example, one or more of the developer users 126, 128 may check out a mainline of a software application from a code repository 118, which may be part of an SCM. The commit operation 130 may include changes to the previous mainline build. The commit operation 130 may result in a new build 120.

The testing system 102 may perform integration and acceptance tests on the changes implemented by the new build 120. The testing system 102 may comprise a test case execution system 104 for executing test cases, a failure clustering system 106 and a corrective action system 108. The various systems 102, 108, 110, 112 may be implemented using various hardware and/or software subcomponents of the testing system 102. In some examples, one or more of the systems 108, 110, 112 is implemented on a discrete computing device or set of computing devices.

The testing system 102 is configured to test the new build 120 by applying one or more test cases. A test case may comprise input data describing a set of input parameters provided to a build and result data describing how the build is expected to behave when provided with the set of input parameters. The test case execution system 104 may apply a test case to the new build 120 by executing the new build 120, applying the test parameters to the new build 120, and observing the response of the new build 120. The new build 120 may pass the test case if it responds to the input data in the way described by the result data. If a build fails to respond to the input data in the way described by the result data, the build may fail the test case. For example, if the new build 120 crashes during a test case, it may not respond to the input data in the way described by the result data.

Consider an example in which the new build 120 is or includes a database management application. Test case data may comprise a set of one or more queries to be executed by the database management application and result data describing how the database management application should behave in response to the queries. The new build 120 may pass the test case if it generates the expected result data in response to the provided queries. Conversely, the new build 120 may fail the test case if it crashes or generates result data that is different than the expected result data.

If the new build 120 passes all test cases, then it may be deployed as a new mainline build. If the new build 120 generates a crash failure during one or more test cases, the failure clustering system 106 may be utilized to identify duplicate crash failures. For example, the failure clustering system 106 may identify crash failures of the new build 120 that are duplicates of one another. The failure clustering system 106 may also identify crash failures of the new build 120 that are duplicates of other crash failures associated with known errors in the software application.

The failure clustering system 106 may comprise a call stack filtering system 110, a similarity score system 112, and a classification system 114. The call stack filtering system 110 may access and filter call stacks associated with crash failures of the new build 120. A call stack is data generated, for example, by the new build 120 during execution to describe functions called during execution of the new build 120. The call stack may also indicate an order in which the function calls were made. In this way, the call stack resulting from a test case failure may indicate the functions that were called, including functions that were called and may have been executing at or near the time that the new build 120 crash.

In some examples, a call stack is generated as part of a crash dump file generated when the software application crashes. In some examples, a crash dump file may include multiple sections describing the state of the software application, the computing system executing the software application, and/or the like. The call stack may be a section of the crash dump file that records code executed leading to the crash. In some examples, accessing the call stack comprises accessing the crash dump file and extracting the call stack from the crash dump file.

The call stack filtering system 110 may apply filtering to an accessed call stack. The filtering may include adding function calls to the call stack, removing function calls to the call stack, and/or changing the order of function calls in the call stack. Modifications to the call stack made by the call stack filtering system 110 may make the function calls listed by a resulting filtered call stack more relevant to the described crash.

In some examples, filtering the call stack may include identifying calls to stable component functions and changing the position of the stable component function calls in the call stack. For example, the function indicated by the function call at the top or most recent position of the call stack may be highly relevant to the cause of the crash. This may be because the function calls at the top or most recent positions of the call stack may have been the most recent function calls made by the software application before the crash. In some software applications, however, calls to stable component functions may commonly appear at or near the top of the call stack. Such calls to stable component functions may not be as relevant to the cause of the crash. In some examples, the call stack filtering system 110 may identify calls to stable component functions in the call stack and move the identified calls to a lower position in the call stack. In some examples, calls to stable component functions may be moved to the end of the call stack.

In some examples, the call stack filtering system 110 may determine a function score for some or all of the functions referenced by the call stack. The function score may be determined in any suitable manner. In some examples, the function score is determined based on the frequency of the function in the considered call stack, the frequency of the function across all analyzed call stacks, and the total number of call stacks. The function score for a function call may indicate the relevance of the function call to the crash. An example for generating a function score for a function x in a call stack y is given by Equation [1] below:

$${Function}_{{score}_{x , y}} = {tf}_{x , y} \times {log}_{} ( \frac{N}{{df}_{x}} ) \qquad [ 1 ]$$

In the example of Equation [1], tf_{x,y} indicates a frequency of the function x in the call stack y. The value dfₓ indicates the frequency of the function x across a total number of considered call stacks. The value N is the total number of considered call stacks. The call stack filtering system 110 may modify the order of function calls in the call stack according to the function scores of the respective functions. In some examples, the call stack filtering system 110 may select the function call having the highest function score and move it to the top of the call stack.

In some examples, the call stack filtering system 110 may also identify function calls to recursive functions. A recursive function is a function that calls itself. For example, a software application may implement a recursive loop that calls multiple versions of a function until an end condition is met. In some examples, recursive function calls may artificially increase the number of calls to a particular function in the call stack. Accordingly, the call stack filtering system 110 may identify multiple recursive function calls in the call stack. The call stack filtering system 110 may compress the call stack to include only a single function call to the recursive function.

Consider the following example call stack given by TABLE 1 below:

TABLE 1

| Position | Function | Component |
|---|---|---|
| 0 | ƒ_{q0} | C1 |
| 1 | ƒ_{q1} | C1 |
| 2 | ƒ_{q2} | C2 |
| 3 | ƒ_{q4} | C2 |
| 4 | ƒ_{q2} | C2 |
| 5 | ƒ_{q5} | C3 |
| 6 | ƒ_{q6} | C3 |

TABLE 1 includes three columns. A position column indicates the position of function calls in the call stack. The position 0 is, prior to filtering, the last function call made by the software application before crashing. The position 6 is the last function call indicated by this call stack. A function column indicates a name of the function that was called by each function call in the call stack. A component column references a component of the software application that is executed to execute the called function.

In this example, the filtering system 110 may determine that the component C1 is a stable component. Accordingly, the filtering system 110 may move the function calls at positions 0 and 1 two positions 5 and 6 respectively, for example, as shown by TABLE 2 below:

TABLE 2

| Position | Function | Component |
|---|---|---|
| 0 | ƒ_{q2} | C2 |
| 1 | ƒ_{q4} | C2 |
| 2 | ƒ_{q2} | C2 |
| 3 | ƒ_{q5} | C3 |
| 4 | ƒ_{q6} | C3 |
| 5 | ƒ_{q0} | C1 |
| | ƒ_{q1} | C1 |

Example function scores for the functions indicated by the call stack shown by TABLES 1 and 2 over an example set of considered call stacks are given by TABLE 3 below:

TABLE 3

| Position | Function | Function Score |
|---|---|---|
| 0 | ƒ_{q2} | 1.8 |
| 1 | ƒ_{q4} | 3 |
| 2 | ƒ_{q2} | 1.8 |
| 3 | ƒ_{q5} | 1.5 |
| 4 | ƒ_{q6} | 1.3 |
| 5 | ƒ_{q0} | N |
| 6 | ƒ_{q1} | N |

In some examples, calls to stable components may not be scored. For example, it may not be desirable to change the position of the stable component to a higher position in the call stack. In the example of TABLE 3, the call to ƒ_{q4} at position 1 has the highest function score. The call stack filtering system 110 may move the call to ƒ_{q4} to the top of the call stack at position 0, as shown by TABLE 4 below:

TABLE 4

| Position | Function | Function Score |
|---|---|---|
| 0 | ƒ_{q4} | 3 |
| 1 | ƒ_{q2} | 1.8 |
| 2 | ƒ_{q2} | 1.8 |
| 3 | ƒ_{q5} | 1.5 |
| 4 | ƒ_{q6} | 1.3 |
| 5 | ƒ_{q0} | N |
| 6 | ƒ_{q1} | N |

The example call stack of TABLES 1-4 includes multiple recursive calls to the function labeled ƒ_{q2}. In some examples, the call stack filtering system 110 may remove one of the function calls to the function ƒ_{q2}, as shown by TABLE 5 below:

TABLE 5

| Position | Function | Function Score |
|---|---|---|
| 0 | ƒ_{q4} | 3 |
| 1 | ƒ_{q2} | 1.8 |
| 3 | ƒ_{q5} | 1.5 |
| 4 | ƒ_{q6} | 1.3 |
| 5 | ƒ_{q0} | N |
| 6 | ƒ_{q1} | N |

In some examples, when removing a call to a recursive function, the call stack filtering system 110 may select the lower-position function call or calls. In this example, the function call at position 2 was farthest from the top of the call stack and, therefore, was the lower-position function call to the function ƒ_{q2}. The version of the call stack shown at TABLE 5 may be a filtered call stack. It will be appreciated that filtering of call stacks performed by the call stack filtering system 110 may include more or fewer than all of the filtering operations described herein.

The similarity score system 112 may operate on pairs of filtered call stacks to determine a similarity score. In some examples, the pairs of filtered call stacks may be describing crash failures of the new build 120. In some examples, some or all of the pairs of filtered call stacks may include a filtered call stack generated from a crash failure of the new build 120 and a call stack generated from a crash failure of a prior build of the software application. For example, filtered call stacks describing crash failures of previous builds of the software application may be stored at a clustering data store 116. Clustering data store 116 may also store indications of relationships between filtered call stacks. For example, filtered call stacks that have been determined to be the result of duplicate crashes may be stored in association with one another at the clustering data store 116.

The similarity score generated by the similarity score system 112 may be an indication of the similarity between the two considered call stacks. The similarity score may be determined such that pairs of call stacks having a high similarity score are likely to have been generated by duplicate crashes of the software application.

An example model for generating a similarity score between two filtered call stacks is given by Equation [2] below:

$$Similarity = \frac{{\sum }_{{fc}_{i} ∈ SF} {e}^{- m \cdot {pos}_{i}} + {\sum }_{{fc}_{j} ∈ SF} {e}^{- m \cdot {pos}_{j}}}{{\sum }_{i = 0}^{q} {e}^{- m \cdot i} + {\sum }_{j = 0}^{t} {e}^{- m \cdot j}} \qquad [ 2 ]$$

In Equation [2], the numerator is based on the position weights associated with same functions. The position weight for a function call in a call stack may be or be derived from the position of the function call in the call stack. For example, referring back to TABLE 5, the position weight of the respective function calls may be equal to the value at the column labeled “position.” In this example, a lower position weight is closer to the top of the call stack. It will be appreciated, however, that, in some examples, position weights may decrease with distance from the top of the call stack.

Same functions are functions that are called by both the source call stack and the target call stack. For example, each same function may have a position weight pos; with respect to the source call stack and a position weight posⱼ with respect to the target call stack. As shown by Equation [2] the numerator is the sum of exponentiated position weights of same functions in the source call stack and the sum of exponentiated position weights of same functions in the target call stack. The denominator may be based on aggregating the exponentiated position weights of all functions across both the source call stack and the target call stack.

In the example of Equation [2], the value m is a tuning parameter. The tuning parameter may determine the impact of function position on similarity scores. In some examples, the tuning parameter may be set to control the degree to which the model considers function position when computing similarity.

The classification system 114 may utilize similarity scores determined between sets of call stacks to classify call stacks as relating to duplicate crashes. For example, the classification system 114 compare a new filtered call stack to one or more other call stacks corresponding to known clusters of duplicate crashes. For example, the classification system 114 may request that the similarity score system 112 generate similarity scores for the new call stack and the one or more other call stacks corresponding to the known clusters of duplicate crashes. If the similarity score between the new call stack and one of the other call stacks is greater than a threshold value, then the classification system 114 may determine that the crash described by the new call stack is a duplicate of the crash considered by the other considered call stack. In this way, the classification system may determine whether the new call stack is due to a novel crash or is a duplicate of a previously recorded crash.

The corrective action system 108 may execute one or more corrective actions based on the new build 120 and/or the commit operation 130 from which it originated. In some examples, the corrective action system 108 sends a report message 140 to one or more developer users 132, 134. The report message 140 may comprise an indication of the commit operation 130 and/or the new build 120. In some examples, the report message 140 includes or describes the call stacks of one or more crash failures of the new build 120 during the application of test cases. For example, the report message 140 may provide an indication of a component or other portion of the software application that is associated with each function call in the call stack or call stacks.

The report message 140 may also provide an indication of whether any crash failures of the new build 120 are duplicates of one another and/or duplicates of known errors in the software application. In some examples, the corrective action system 108 routes the report message 140 to the developer user 126, 128 that submitted the error-inducing commit operation or to a different developer user 132, 134. The developer users 132, 134 may receive the report message 140 using one or more user computing devices 136, 138, which may be similar to user computing devices 122, 124 described herein.

In some examples, the corrective action system 108 stores error data 142 at an error data store 144. The error data 142 describes the commit operation 130 and/or new build 120 that failed at least one test case. In some examples, the error data 142 also describes one or more report messages 140 provided to one or more developer users 126, 128, 132, 134 for correcting the commit operation 130.

Another example corrective action that may be taken by the corrective action system 108 includes reverting the software application to a good build. A good build may be a build that was generated by a commit operation prior to the commit operation 130. In some examples, the good build is the build generated by the commit operation immediately before the error-inducing commit operation 130.

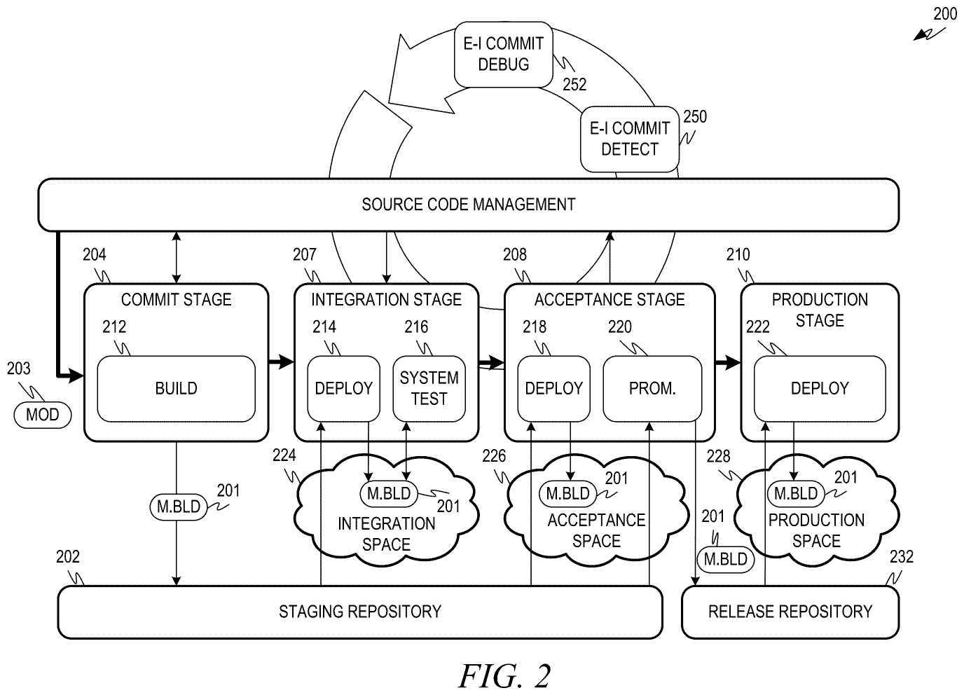

FIG. 2 is a diagram showing one example of a CI/CD pipeline 200 incorporating various software testing described herein. The CI/CD pipeline 200 is initiated when a developer user, such as one of developer users 132, 134, submits a build modification 203 to the commit stage 204, initiating a commit operation. The build modification 203 may include a modified version of the mainline build previously downloaded by the developer user 126, 128.

The commit stage 204 executes a commit operation 212 to create and/or refine the modified software application build 201. For example, the mainline may have changed since the time that the developer user 132, 134 downloaded the mainline version used to create the build modification 203. The modified software application build 201 generated by commit operation 212 includes the changes implemented by the modification 203 as well as any intervening changes to the mainline. The commit operation 212 and/or commit stage 204 stores the modified software application build 201 to a staging repository 202 where it can be accessed by various other stages of the CI/CD pipeline 200.

An integration stage 207 receives the modified software application build 201 for further testing. A deploy function 214 of the integration stage 207 deploys the modified software application build 201 to an integration space 224. The integration space 224 is a test environment to which the modified software application build 201 can be deployed for testing. While the modified software application build 201 is deployed at the integration space 224, a system test function 216 performs one or more integration tests on the modified software application build 201. In some examples, the testing system 102 of FIG. 1 may be utilized to perform all or part of the system test function 216. If the modified software application build 201 fails one or more of the test cases, it may be returned to the developer user 132, 134 for correction. If the modified software application build 201 passes testing, the integration stage 207 provides an indication passage to an acceptance stage 208.

The acceptance stage 208 uses a deploy function 218 to deploy the modified software application build 201 to an acceptance space 226. The acceptance space 226 is a test environment to which the modified software application build 201 can be deployed for testing. While the modified software application build 201 is deployed at the acceptance space 226, a promotion function 220 applies one or more promotion tests to determine whether the modified software application build 201 is suitable for deployment to a production environment. Example acceptance tests that may be applied by the promotion function 220 include Newman tests, UiVeri5 tests, Gauge BDD tests, various security tests, etc. If the modified software application build 201 fails the testing, it may be returned to the developer user 132, 134 for correction. If the modified software application build 201 passes the testing, the promotion function 220 may write the modified software application build 201 to a release repository 232, from which it may be deployed to production environments.

The example of FIG. 2 shows a single production stage 210. The production stage 210 includes a deploy function 222 that reads the modified software application build 201 from the release repository 232 and deploys the modified software application build 201 to a production space 228. The production space 228 may be any suitable production space or environment as described herein.

The various examples for software testing described herein may be implemented during the acceptance stage 208 and/or the integration stage 207. An error-inducing detection operation 250 may be executed by the testing system 102 utilizing fault localization, as described herein. An error-inducing commit debug or correction operation 252 may be executed by the testing system 102 (e.g., the corrective action system 108) as described herein.

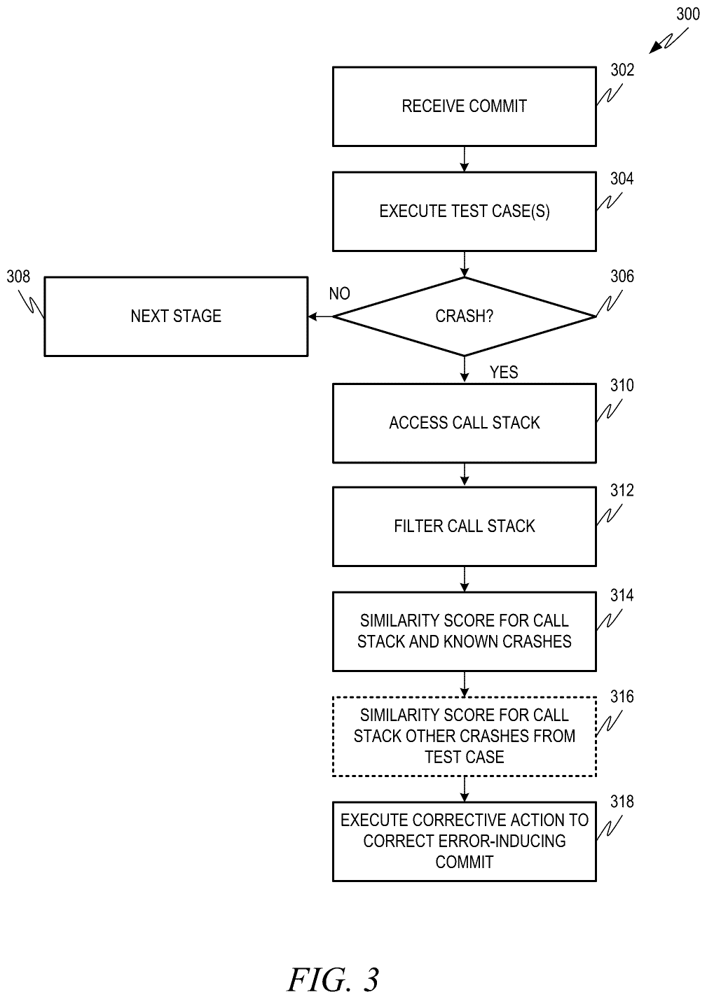

FIG. 3 is a flowchart showing one example of a process flow 300 that may be executed in the environment 100 of FIG. 1. At operation 302, the testing system may receive an indication of a commit operation. In some examples, the indication of the commit operation is, includes, and/or references a new build of the software application that is the result of the commit operation.

At operation 304, the testing system 102 may execute one or more test cases on the new build. At operation 306, the testing system 102 may determine if any of the test cases resulted in a crash failure. If none of the test cases resulted in a crash failure, then the testing system 102 may move to a next stage at operation 308. In some examples, this may include moving to a next stage of testing and/or loading the new build to a production environment. In other examples, as described herein, the new build may fail one or more test cases without crashing by generating and correct data. If the new build does not experience any crash failures, but still fails one or more test cases, then a corrective action, as described herein, may be taken.

If one or more crash failures did occur during execution of the test cases, then the testing system 102 may access the call stack associated with the crash failure at operation 310. If more than one crash failure occurred, then the testing system 102 may access call stacks for each respective crash failure. At operation 312, the testing system 102 may filter the call stack or call stacks, for example, as described herein.

At operation 314, the testing system may determine similarity scores for each call stack from the new build and call stacks for a set of one or more known crashes. If the similarity score for a call stack from the new build and a call stack for a known crash is higher than a threshold, then the call stack from the new build may be determined to be a duplicate crash of the known crash.

At optional operation 316, the testing system 102 may determine similarity scores for pairs of call stacks generated by the new build. For example, operation 316 may be executed if there was more than one crash failure of the new build. If the similarity score for two call stacks from the new build is greater than the threshold, then the two call stacks may be determined to result from duplicate crash failures. At operation 318, the testing system 102 may perform a corrective action, for example, as described herein.

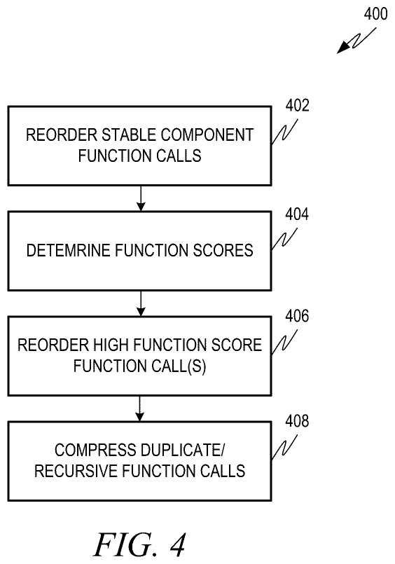

FIG. 4 is a flowchart showing one example of a process flow 400 that may be executed in the environment 100 of FIG. 1 to filter a call stack. At operation 402, the testing system may re-order stable component function calls from the call stack. The stable component function calls may be function calls to components of the software application that are known to be stable. Components known to be stable may be identified in any suitable manner such as, for example, by referring to a stored list of stable components. Reordering the stable component function calls may include moving stable component function calls to positions behind at least one other function call that is not to a stable component.

At operation 404, the testing system 102 may determine function scores for each function called in the call stack. The function scores may be determined, for example, as described herein utilizing a relationship similar to the function given by Equation [1]. At operation 406, the testing system 102 may reorder one or more function calls based on function scores. For example, the testing system 102 may select the function having the highest function score (e.g. indicating the highest relevance of the called function). The function having the highest function score may be moved to the top of the call stack, for example, ahead of at least one other function call that was made before than the moved function call. At operation 408, the testing system 102 may compress duplicate and/or recursive function calls. This may include removing calls to the same function from the call stack. In some examples, removing calls to the same function from the call stack may not change the call stack position or weight associated with other function calls.

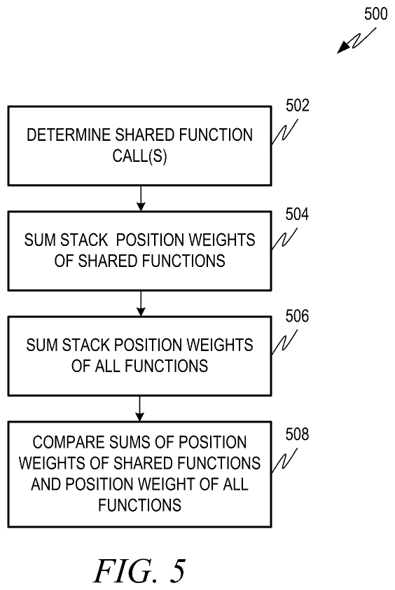

FIG. 5 is a flowchart showing one example of a process flow 500 that may be executed in the environment 100 of FIG. 1 to determining a similarity score between a source call stack and a target call stack. At operation 502, the testing system 102 may determine shared function calls between the source call stack and the target call stack. Shared function calls are function calls that are in both the source call stack and the target call stack. In some examples, if there are no shared function calls, then the source call stack and the target call stack may not be similar and, therefore, may not represent duplicate crash failures.

At operation 504, the testing system 102 may generate a sum of stack call position weights based on the shared functions. In some examples, the sum is a sum of exponentiated position weights, for example, as described by Equation [2]. The numerator of Equation [2] is one example of how the operation 504 may be performed. At operation 506, the testing system 102 may generate a sum of all stack position weights in the source call stack and the target call stack. In some examples, the sum is a sum of exponentiated position weights, for example, as described by Equation [2]. The denominator of Equation [2] is one example of how the operation 506 may be performed. At operation 508, the testing system 102 may compare the sum of position weights of shared functions and the sum of all position weights, for example, as described by Equation [2].

In view of the disclosure above, various examples are set forth below. It should be noted that one or more features of an example, taken in isolation or combination, should be considered within the disclosure of this application.

### EXAMPLES

Example 1 is a computing system for debugging a software application, comprising: at least one hardware processor programmed to perform operations comprising: accessing a call stack, the call stack describing a first plurality of function calls made by the software application prior to a first crash of the software application and an order of the first plurality of function calls, the order of the first plurality of function calls being based on when the respective function calls were made by the software application; filtering the call stack to generate a first filtered call stack, the first filtered call stack indicating at least one of a change to the first plurality of function calls or a change to the order of the first plurality of function calls; determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and based on the similarity score being greater than a threshold value, storing an indication that the first crash and the second crash are duplicate crashes.

In Example 2, the subject matter of Example 1 optionally includes the filtering of the call stack comprising: determining that the call stack includes at least one call to a stable component function; and moving the at least one call to the stable component function to a position in the order of the first plurality of function calls that is behind at least one function call made after the at least one call to the stable component function.

In Example 3, the subject matter of any one or more of Examples 1-2 optionally include the filtering of the call stack comprising: determining a plurality of function scores for a plurality of functions associated with the first plurality of function calls, the determining of the plurality of function scores comprising: determining a first function score of the plurality of function scores, the first function score describing a first function called by a first function call of the first plurality of function calls; and determining a second function score of the plurality of function scores, the second function score describing a second function called by a second function call of the first plurality of function calls; determining that the first function score is a highest function score of the plurality of function scores; and moving the first function call to a position in the order of the first plurality of function calls that is ahead of at least one function call made before the first function call.

In Example 4, the subject matter of Example 3 optionally includes the determining of the first function score being based at least in part of on a frequency of calls to the first function in the call stack and a frequency of calls to the first function across a plurality of call stacks.

In Example 5, the subject matter of Example 4 optionally includes the determining of the first function score also being based at least in part on a number of the plurality of call stacks.

In Example 6, the subject matter of any one or more of Examples 1-5 optionally include the filtering of the call stack comprising: determining that a first function call of the first plurality of function calls and a second function call of the first plurality of function calls are to a common function; and removing the second function call from the call stack.

In Example 7, the subject matter of any one or more of Examples 1-6 optionally include the determining of the similarity score comprising determining a set of shared functions that are indicated by the first filtered call stack and the second filtered call stack, the similarity score being based at least in part on the set of shared functions.

In Example 8, the subject matter of Example 7 optionally includes the determining of the similarity score further comprising: determining a sum based on first position weights describing positions of the set of shared functions in the order of the first plurality of function calls indicated by the first filtered call stack; and determining a sum based on second position weights describing positions of the set of shared functions in the order of the second plurality of function calls indicated by the second filtered call stack, the similarity score being based at least in part on the sum of the first position weights and the sum of second position weights.

In Example 9, the subject matter of Example 8 optionally includes the determining of the similarity score further comprising: determining a sum based on third position weights based on the order of the first plurality of function calls indicated by the first filtered call stack; and determining a sum based on fourth position weights based on the order of the second plurality of function calls indicated by the second filtered call stack, the similarity score being based at least in part on comparing the sum based on the first position weights and the sum based on the second position weights to the sum based on the third position weights and the sum based on the fourth position weights.

In Example 10, the subject matter of any one or more of Examples 8-9 optionally include the similarity score also being based at least in part on a tuning parameter.

Example 11 is a method for debugging a software application, comprising: accessing a call stack, the call stack describing a first plurality of function calls made by the software application prior to a first crash of the software application and an order of the first plurality of function calls, the order of the first plurality of function calls being based on when the respective function calls were made by the software application; filtering the call stack to generate a first filtered call stack, the first filtered call stack indicating at least one of a change to the first plurality of function calls or a change to the order of the first plurality of function calls; determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and based on the similarity score being greater than a threshold value, storing an indication that the first crash and the second crash are duplicate crashes.

In Example 12, the subject matter of Example 11 optionally includes the filtering of the call stack comprising: determining that the call stack includes at least one call to a stable component function; and moving the at least one call to the stable component function to a position in the order of the first plurality of function calls that is behind at least one function call made after the at least one call to the stable component function.

In Example 13, the subject matter of any one or more of Examples 11-12 optionally include the filtering of the call stack comprising: determining a plurality of function scores for a plurality of functions associated with the first plurality of function calls, the determining of the plurality of function scores comprising: determining a first function score of the plurality of function scores, the first function score describing a first function called by a first function call of the first plurality of function calls; and determining a second function score of the plurality of function scores, the second function score describing a second function called by a second function call of the first plurality of function calls; determining that the first function score is a highest function score of the plurality of function scores; and moving the first function call to a position in the order of the first plurality of function calls that is ahead of at least one function call made before the first function call.

In Example 14, the subject matter of Example 13 optionally includes the determining of the first function score being based at least in part of on a frequency of calls to the first function in the call stack and a frequency of calls to the first function across a plurality of call stacks.

In Example 15, the subject matter of Example 14 optionally includes the determining of the first function score also being based at least in part on a number of the plurality of call stacks.

In Example 16, the subject matter of any one or more of Examples 11-15 optionally include the filtering of the call stack comprising: determining that a first function call of the first plurality of function calls and a second function call of the first plurality of function calls are to a common function; and removing the second function call from the call stack.

In Example 17, the subject matter of any one or more of Examples 11-16 optionally include the determining of the similarity score comprising determining a set of shared functions that are indicated by the first filtered call stack and the second filtered call stack, the similarity score being based at least in part on the set of shared functions.

In Example 18, the subject matter of Example 17 optionally includes the determining of the similarity score further comprising: determining a sum based on first position weights describing positions of the set of shared functions in the order of the first plurality of function calls indicated by the first filtered call stack; and determining a sum based on second position weights describing positions of the set of shared functions in the order of the second plurality of function calls indicated by the second filtered call stack, the similarity score being based at least in part on the sum of the first position weights and the sum of second position weights.

In Example 19, the subject matter of Example 18 optionally includes the determining of the similarity score further comprising: determining a sum based on third position weights based on the order of the first plurality of function calls indicated by the first filtered call stack; and determining a sum based on fourth position weights based on the order of the second plurality of function calls indicated by the second filtered call stack, the similarity score being based at least in part on comparing the sum based on the first position weights and the sum based on the second position weights to the sum based on the third position weights and the sum based on the fourth position weights.

Example 20 is a non-transitory machine-readable medium comprising instructions thereon that, when executed by at least one hardware processor, because the at least one hardware processor to perform operations comprising: accessing a call stack, the call stack describing a first plurality of function calls made by a software application prior to a first crash of the software application and an order of the first plurality of function calls, the order of the first plurality of function calls being based on when the respective function calls were made by the software application; filtering the call stack to generate a first filtered call stack, the first filtered call stack indicating at least one of a change to the first plurality of function calls or a change to the order of the first plurality of function calls; determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and based on the similarity score being greater than a threshold value, storing an indication that the first crash and the second crash are duplicate crashes.

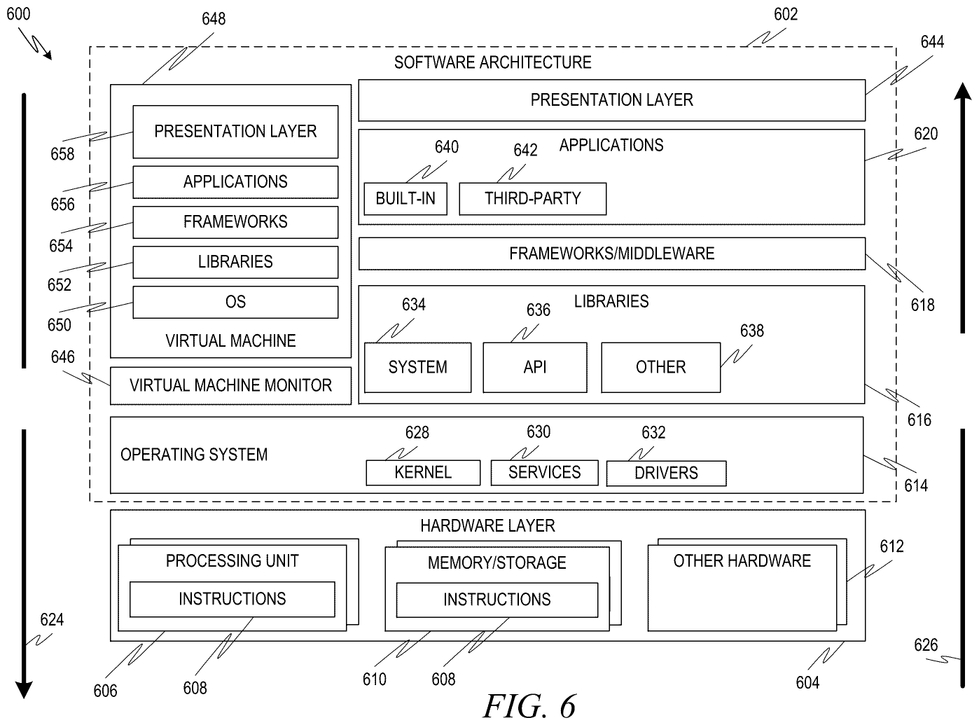

FIG. 6 is a block diagram 600 showing one example of a software architecture 602 for a computing device. The software architecture 602 may be used in conjunction with various hardware architectures, for example, as described herein. FIG. 6 is merely a non-limiting example of a software architecture and many other architectures may be implemented to facilitate the functionality described herein. The software architecture 602 and various other components described in FIG. 6 may be used to implement various other systems described herein. For example, the software architecture 602 shows one example way for implementing a testing system 102 or other computing devices described herein.

In FIG. 6, a representative hardware layer 604 is illustrated and can represent, for example, any of the above referenced computing devices. In some examples, the hardware layer 604 may be implemented according to the architecture of the computer system of FIG. 6.

The representative hardware layer 604 comprises one or more processing units 606 having associated executable instructions 608. Executable instructions 608 represent the executable instructions of the software architecture 602, including implementation of the methods, modules, systems, and components, and so forth described herein and may also include memory and/or storage modules 610, which also have executable instructions 608. Hardware layer 604 may also comprise other hardware as indicated by other hardware 612 which represents any other hardware of the hardware layer 604, such as the other hardware illustrated as part of the software architecture 602.

In the example architecture of FIG. 6, the software architecture 602 may be conceptualized as a stack of layers where each layer provides particular functionality. For example, the software architecture 602 may include layers such as an operating system 614, libraries 616, middleware layer 618 (sometimes referred to as frameworks), applications 620, and presentation layer 644. Operationally, the applications 620 and/or other components within the layers may invoke API calls 624 through the software stack and access a response, returned values, and so forth illustrated as messages 626 in response to the API calls 624. The layers illustrated are representative in nature and not all software architectures have all layers. For example, some mobile or special purpose operating systems may not provide the middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. In some examples, the services 630 include an interrupt service. The interrupt service may detect the receipt of an interrupt and, in response, cause the software architecture 602 to pause its current processing and execute an interrupt service routine (ISR) when an interrupt is accessed.

The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and/or the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and/or the like. The libraries 616 may also include a wide variety of other libraries 638 to provide many other APIs to the applications 620 and other software components/modules.

The middleware layer 618 (also sometimes referred to as frameworks) may provide a higher-level common infrastructure that may be utilized by the applications 620 and/or other software components/modules. For example, the middleware layer 618 may provide various graphic user interface (GUI) functions, high-level resource management, high-level location services, and so forth. The middleware layer 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a contacts application, a browser application, a book reader application, a location application, a media application, a messaging application, and/or a game application. Third-party applications 642 may include any of the built-in applications 640 as well as a broad assortment of other applications. In a specific example, the third-party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 642 may invoke the API calls 624 provided by the mobile operating system, such as operating system 614, to facilitate functionality described herein.

The applications 620 may utilize built-in operating system functions (e.g., kernel 628, services 630 and/or drivers 632), libraries (e.g., system 634, API libraries 636, and other libraries 638), and middleware layer 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. For example, the various environments described herein may implement one or more virtual machines executing to provide a software application or service. The example of FIG. 6 illustrates by virtual machine 648. A virtual machine creates a software environment where applications/modules can execute as if they were executing on a hardware computing device. A virtual machine 648 is hosted by a host operating system (operating system 614) and typically, although not always, has a virtual machine monitor 646, which manages the operation of the virtual machine 648 as well as the interface with the host operating system (i.e., operating system 614). A software architecture executes within the virtual machine 648. The software architecture may be or include, for example, an operating system 650, libraries 652, frameworks/middleware 654, applications 656 and/or presentation layer 658. These layers of software architecture executing within the virtual machine 648 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

Computer software, including code for implementing software services, can be written in any form of programming language, including compiled or interpreted languages, and it can be deployed in any form, including as a standalone program or as a module, subroutine, or other unit suitable for use in a computing environment. Computer software can be deployed to be executed on one computer or on multiple computers at one site or distributed across multiple sites and interconnected by a communication network.

In example embodiments, operations may be performed by one or more programmable processors executing a computer program to perform functions by operating on input data and generating output.

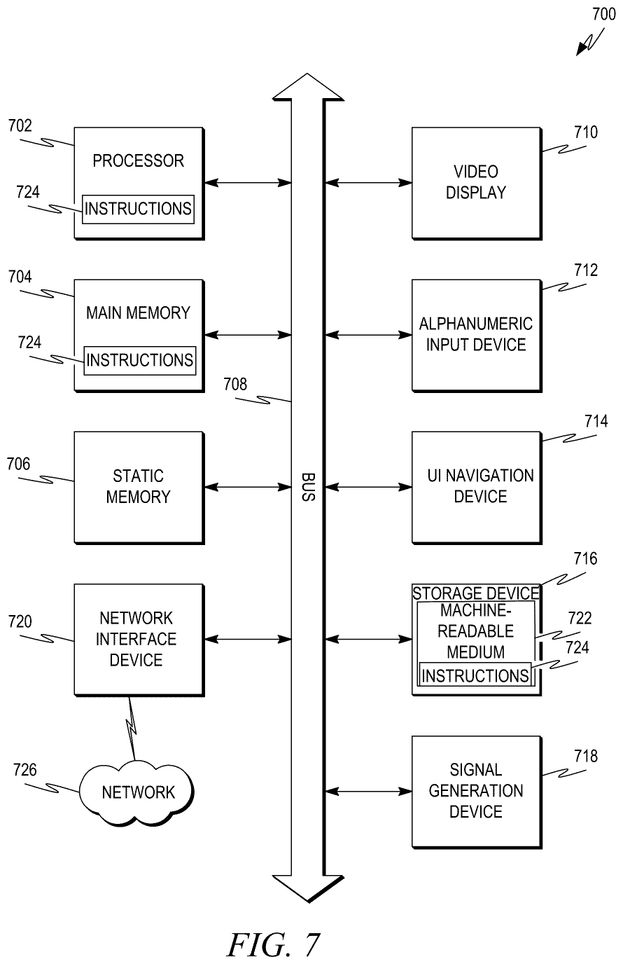

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard or a touch-sensitive display screen), a user interface (UI) navigation (or cursor control) device 714 (e.g., a mouse), a storage device 716, such as a disk drive unit, a signal generation device 718 (e.g., a speaker), and a network interface device 720.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media 722.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present disclosure, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computing system for debugging a software application, comprising:
at least one hardware processor programmed to perform operations comprising:
accessing a call stack, the call stack describing a first plurality of function calls made by the software application prior to a first crash of the software application and an order of the first plurality of function calls, the order of the first plurality of function calls being based on when the respective function calls were made by the software application;
filtering the call stack to generate a first filtered call stack, the first filtered call stack indicating at least one of a change to the first plurality of function calls or a change to the order of the first plurality of function calls;
determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and
based on the similarity score being greater than a threshold value, storing an indication that the first crash and the second crash are duplicate crashes.

2. The computing system of claim 1, the filtering of the call stack comprising:
determining that the call stack includes at least one call to a stable component function; and
moving the at least one call to the stable component function to a position in the order of the first plurality of function calls that is behind at least one function call made after the at least one call to the stable component function.

3. The computing system of claim 1, the filtering of the call stack comprising:
determining a plurality of function scores for a plurality of functions associated with the first plurality of function calls, the determining of the plurality of function scores comprising:
determining a first function score of the plurality of function scores, the first function score describing a first function called by a first function call of the first plurality of function calls; and
determining a second function score of the plurality of function scores, the second function score describing a second function called by a second function call of the first plurality of function calls;
determining that the first function score is a highest function score of the plurality of function scores; and
moving the first function call to a position in the order of the first plurality of function calls that is ahead of at least one function call made before the first function call.

4. The computing system of claim 3, the determining of the first function score being based at least in part of on a frequency of calls to the first function in the call stack and a frequency of calls to the first function across a plurality of call stacks.

5. The computing system of claim 4, the determining of the first function score also being based at least in part on a number of the plurality of call stacks.

6. The computing system of claim 1, the filtering of the call stack comprising:
determining that a first function call of the first plurality of function calls and a second function call of the first plurality of function calls are to a common function; and
removing the second function call from the call stack.

7. The computing system of claim 1, the determining of the similarity score comprising determining a set of shared functions that are indicated by the first filtered call stack and the second filtered call stack, the similarity score being based at least in part on the set of shared functions.

8. The computing system of claim 7, the determining of the similarity score further comprising:
determining a sum based on first position weights describing positions of the set of shared functions in the order of the first plurality of function calls indicated by the first filtered call stack; and
determining a sum based on second position weights describing positions of the set of shared functions in the order of the second plurality of function calls indicated by the second filtered call stack, the similarity score being based at least in part on the sum of the first position weights and the sum of second position weights.

9. The computing system of claim 8, the determining of the similarity score further comprising:
determining a sum based on third position weights based on the order of the first plurality of function calls indicated by the first filtered call stack; and
determining a sum based on fourth position weights based on the order of the second plurality of function calls indicated by the second filtered call stack, the similarity score being based at least in part on comparing the sum based on the first position weights and the sum based on the second position weights to the sum based on the third position weights and the sum based on the fourth position weights.

10. The computing system of claim 8, the similarity score also being based at least in part on a tuning parameter.

11. A method for debugging a software application, comprising:
accessing a call stack, the call stack describing a first plurality of function calls made by the software application prior to a first crash of the software application and an order of the first plurality of function calls, the order of the first plurality of function calls being based on when the respective function calls were made by the software application;
filtering the call stack to generate a first filtered call stack, the first filtered call stack indicating at least one of a change to the first plurality of function calls or a change to the order of the first plurality of function calls;
determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and
based on the similarity score being greater than a threshold value, storing an indication that the first crash and the second crash are duplicate crashes.

12. The method of claim 11, the filtering of the call stack comprising:
determining that the call stack includes at least one call to a stable component function; and
moving the at least one call to the stable component function to a position in the order of the first plurality of function calls that is behind at least one function call made after the at least one call to the stable component function.

13. The method of claim 11, the filtering of the call stack comprising:
determining a plurality of function scores for a plurality of functions associated with the first plurality of function calls, the determining of the plurality of function scores comprising:
determining a first function score of the plurality of function scores, the first function score describing a first function called by a first function call of the first plurality of function calls; and
determining a second function score of the plurality of function scores, the second function score describing a second function called by a second function call of the first plurality of function calls;
determining that the first function score is a highest function score of the plurality of function scores; and
moving the first function call to a position in the order of the first plurality of function calls that is ahead of at least one function call made before the first function call.

14. The method of claim 13, the determining of the first function score being based at least in part of on a frequency of calls to the first function in the call stack and a frequency of calls to the first function across a plurality of call stacks.

15. The method of claim 14, the determining of the first function score also being based at least in part on a number of the plurality of call stacks.

16. The method of claim 11, the filtering of the call stack comprising:
determining that a first function call of the first plurality of function calls and a second function call of the first plurality of function calls are to a common function; and
removing the second function call from the call stack.

17. The method of claim 11, the determining of the similarity score comprising determining a set of shared functions that are indicated by the first filtered call stack and the second filtered call stack, the similarity score being based at least in part on the set of shared functions.

18. The method of claim 17, the determining of the similarity score further comprising:
determining a sum based on first position weights describing positions of the set of shared functions in the order of the first plurality of function calls indicated by the first filtered call stack; and
determining a sum based on second position weights describing positions of the set of shared functions in the order of the second plurality of function calls indicated by the second filtered call stack, the similarity score being based at least in part on the sum of the first position weights and the sum of second position weights.

19. The method of claim 18, the determining of the similarity score further comprising:
determining a sum based on third position weights based on the order of the first plurality of function calls indicated by the first filtered call stack; and
determining a sum based on fourth position weights based on the order of the second plurality of function calls indicated by the second filtered call stack, the similarity score being based at least in part on comparing the sum based on the first position weights and the sum based on the second position weights to the sum based on the third position weights and the sum based on the fourth position weights.

20. A non-transitory machine-readable medium comprising instructions thereon that, when executed by at least one hardware processor, because the at least one hardware processor to perform operations comprising:
accessing a call stack, the call stack describing a first plurality of function calls made by a software application prior to a first crash of the software application and an order of the first plurality of function calls, the order of the first plurality of function calls being based on when the respective function calls were made by the software application;
filtering the call stack to generate a first filtered call stack, the first filtered call stack indicating at least one of a change to the first plurality of function calls or a change to the order of the first plurality of function calls;
determining a similarity score for the first crash and a second crash of the software application, the determining of the similarity score being based on comparing the first filtered call stack to a second filtered call stack, the second filtered call stack describing a second plurality of function calls made by the software application prior to the second crash of the software application and an order of the second plurality of function calls; and
based on the similarity score being greater than a threshold value, storing an indication that the first crash and the second crash are duplicate crashes.
